(19) United States
(12) Patent Application Publication
(10) Pub. No.: US 2011/0125297 A1
(43) Pub. Date: May 26, 2011

(54) METHOD FOR SETTING UP A LIST OF AUDIO FILES

(75) Inventors: Jungle Chu, Taipei City (TW); Frankie Huang, Sinjhuang City (TW); Simon Chang, Taipei City (TW)

(73) Assignee: SONY ERICSSON MOBILE COMMUNICATIONS AB, Lund (SE)

(21) Appl. No.: 12/622,624

(22) Filed: Nov. 20, 2009

(51) Int. Cl. G06F 17/00

(52) U.S. Cl. 700/94; 707/705; 707/E17.101

(57) ABSTRACT

A method for setting up a list of audio files and an audio re-production device utilizing the method for setting up the list of audio files are described.

### BACKGROUND OF THE INVENTION

The present invention relates to methods for setting up a list of audio files, a so-called playlist, and to audio reproduction devices utilizing the methods for setting up the playlists.

### BRIEF SUMMARY OF THE INVENTION

According to an embodiment of the present invention, a method for setting up a list of audio files is provided. According to this embodiment, at least one group of audio files from a plurality of audio files is automatically determined. The audio files of each of the at least one group provides a group specific common characteristic. Furthermore, for each of the at least one group, a respective value defining a number or quantity of audio files to be selected from the respective group for the list of audio files is requested from a user. For each of the at least one group the requested number of audio files of the respective group is automatically selected and the selected audio files are automatically added to the list of audio files.

The group specific common characteristic may comprise a name of an interpreter or artist of the audio file. Furthermore, the group specific common characteristic may comprise a name of an album to which the audio file belongs. Moreover, the group specific common characteristic may comprise a genre of the audio file. The genre may comprise categories like pop music, jazz, soul, classic etc. The audio files to be selected from the respective group may be selected randomly from the respective group of audio files.

A user of an audio reproduction device, for example an MP3 player or a mobile phone, may usually have several music albums on the audio reproduction device. Thousands of songs may be stored in categories like albums, interpreters or artists, or music styles. Therefore, conventionally the user has to open each of these categories and select individual songs to create a list of audio files, a so-called playlist. To set up a playlist, the user has to open and close a category, for example album or artist, over and over again to add the songs to the playlist one by one. For example, if the user wants to pick up 100 songs to a playlist, this may take several minutes when the songs are added to the playlist one by one. According to the above-described method of the present invention, a playlist can be created in a much more efficient way. Groups of audio files or songs are automatically determined, wherein each group contains audio files belonging to a category, that means the audio files provide a group specific common characteristic, for example the audio files of one group belong to the same album or have the same artist. The groups are presented to the user, e.g. by displaying the group specific common characteristic, and the user selects a number or quantity of audio files of each group, for example five songs from a first album, six songs from a second album, three songs from a third album and so on. By this a new playlist can be created efficiently and conveniently. The requested number of songs may be selected randomly from the group or may be selected based on an information how much the user likes a song, measured for example by the number of times the user has listened to the song in the past.

According to another embodiment, an audio reproduction device is provided. The device comprises a processing unit having access to a plurality of audio files. The processing unit determines at least one group of audio files from the plurality of audio files and requests from a user of the device for each of the at least one group a respective value defining a number or quantity of audio files to be selected from the respective group. The audio files of each of the at least one group provide a group specific common characteristic, for example a common album or a common artist. Then the processing unit selects for each of the at least one group the requested number of audio files from the respective group and adds the selected audio files to a list of audio files, a so-called playlist.

The audio reproduction device may be a mobile phone, a personal digital assistant, a mobile navigation system, a mobile music player or a computer.

According to a further embodiment, a further method for setting up a list of audio files is provided. At least one group of audio files is determined automatically from a plurality of audio files. The audio files of each of the at least one group provide a group specific common characteristic and each audio file comprises a playing time information indicating a time duration required for playing back the audio file. According to the method, for each of the at least one group a respective time duration information is requested from a user. The time duration information corresponds to a desired total play back time of the audio files from the respective group. Then, for each of the at least one group, one or more audio files are automatically selected such that a total play back time of the selected one or more audio files corresponds approximately to the requested time duration information for the respective group. The selected one or more audio files are added automatically to the list of audio files.

The group specific common characteristic may comprise a name of an artist and/or an interpreter of the audio file. Furthermore, the group specific common characteristic may comprise a name of an album to which the audio file belongs, or a genre of the audio file.

As explained above, when a user wants to set up a list of audio files, a so-called playlist, conventionally the user has to select the files one by one. According to the above-described method, the user can select a playing time for songs from a group of songs having a common characteristic, for example songs from an album or songs from an artist, and in response to this, one or more songs or audio files are automatically added to the playlist, wherein the selected one or more songs have a total play back time as requested by the user. Thus, the playlist can be efficiently and conveniently set up.

According to another embodiment of the present invention, an audio reproduction device is provided comprising a processing unit having access to a plurality of audio files. The processing unit is adapted to determine at least one group of audio files from the plurality of audio files, and to request from a user for each of the at least one group a respective time duration information corresponding to a desired total play back time of audio files from the respective group. The audio files of each of the at least one group provide a group specific common characteristic and each audio file comprises a playing time information indicating a duration required for playing back the audio file. The processing unit is furthermore adapted to select for each of the at least one group one or more audio files such that a total play back time of the selected one or more audio files corresponds approximately to the requested time duration information for the respective group. Finally, the processing unit is configured to add the selected one or more audio files to a list of audio files.

The audio reproduction device may be a device selected from the group comprising a mobile phone, a personal digital assistant, a mobile navigation system, a mobile music player, and a mobile computer.

Although specific features described in the above summary and the following detailed description are described in connection with specific embodiments, it is to be understood that the features of the embodiments described can be combined with each other unless it is noted otherwise.

### BRIEF DESCRIPTION OF THE DRAWINGS

Hereinafter, exemplary embodiments of the invention will be described with reference to the drawings.

FIG. 1 shows an audio reproduction device according to an embodiment of the present invention.

FIG. 2 shows a display of a user interface for setting up a playlist according to a method according to an embodiment of the present invention.

FIG. 3 shows another display of a user interface for setting up a playlist according to a method according to another embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

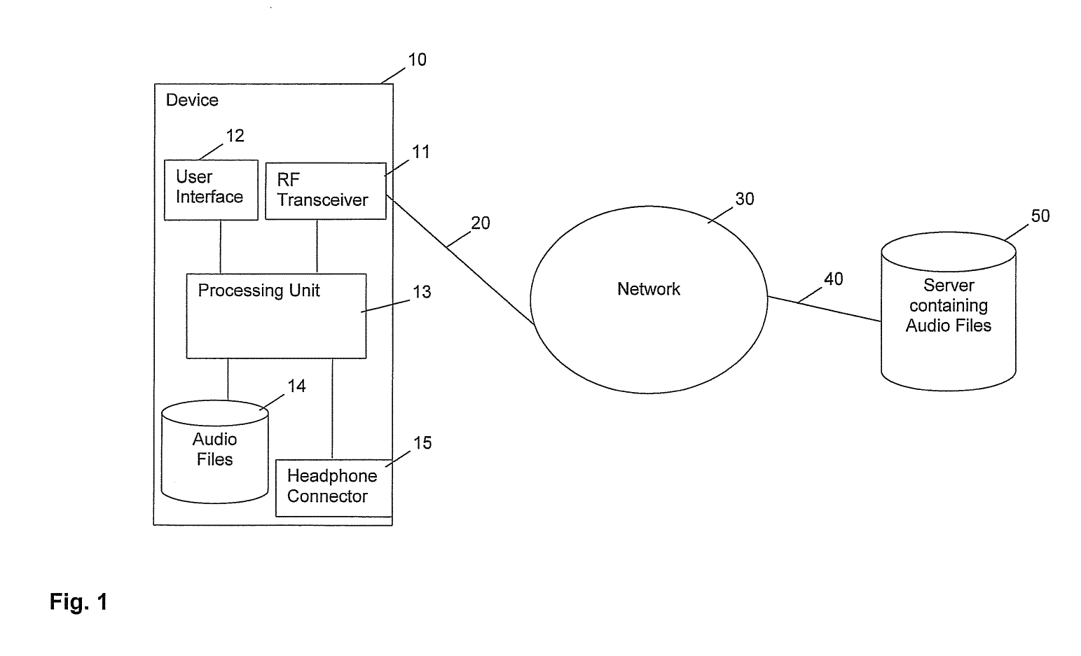

FIG. 1 shows schematically a device 10 which may be connected to a server 50 via a network 30. A connection 20 between the device 10 and the network 30 may be a wireless connection, for example a GSM, UMTS, GPRS or Bluetooth connection. However, connection 20 may be any other kind of wireless or wired connection. Connection 40 between the network 30 and the server 50 may be also any kind of wireless or wired connection. The device 10 may be any kind of mobile or stationary or non-portable device, for example a mobile phone, a mobile audio reproduction device, an MP3 player, a mobile navigation system, a notebook, a laptop, or a stationary personal computer. In the following, it will be assumed that the device 10 is a mobile device, e.g. a mobile phone.

The device 10 comprises a radio frequency transceiver 11, a user interface 12, a processing unit 13, a memory 14, and a head phone connector 15. Instead or additionally to the head phone connector 15, the device 10 may provide one or more loudspeakers. Additionally, the device 10 may comprise additional components, for example a display, a keypad, a loudspeaker, a microphone, and so on, but these components are not shown in FIG. 1 to simplify matters.

The processing unit 13 is connected to the radio frequency transceiver 11, the user interface, the memory 14, and the head phone connector 15. The radio frequency transceiver 11 may utilize a data communication between the processing unit 13 and the server 50 via a wireless connection 20 and the data communication network 30. The memory may be used to store a plurality of audio files which may be played back by the processing unit as audio data which may be output via the head phone connector 15. Additionally, the processing unit 13 may be adapted to download or stream audio data from the server 50 and to play back the downloaded or streamed audio data via the head phone connector 15. For downloading or streaming music from the server 50, a user of the device 10 may be prompted in advance via the user interface 12 for allowing access to the server 50.

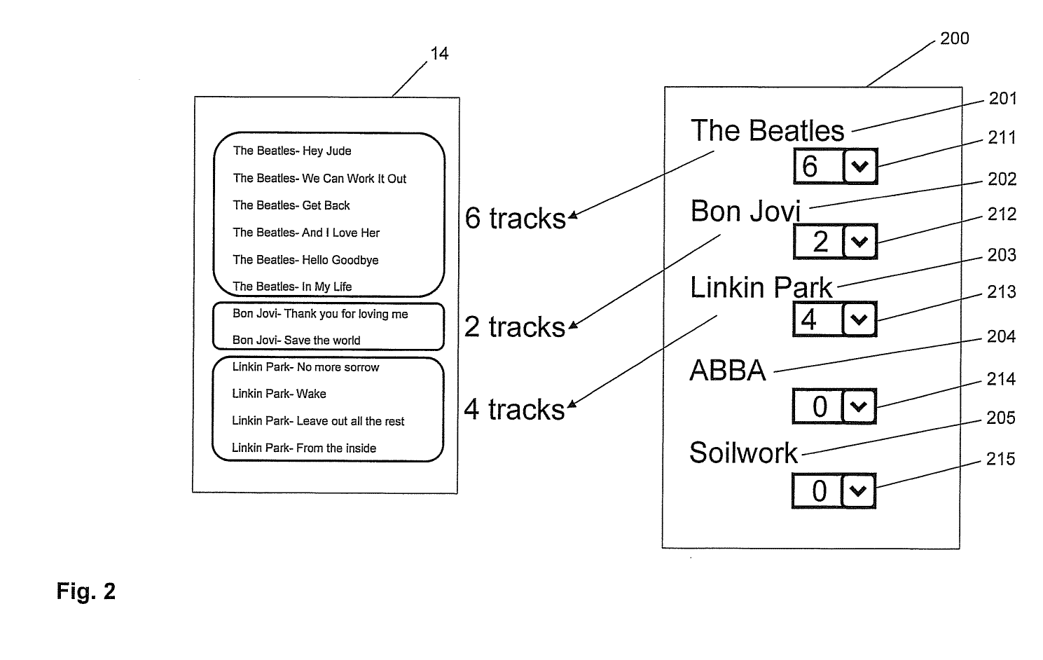

Operation of the processing unit 13 will now be described in more detail in connection with FIGS. 1 and 2.

Assuming a user of the device 10 wants to set up a list of audio files, a so-called playlist, the user selects via the user interface 12 a menu 200 as indicated in FIG. 2. The menu 200 shows a list of artists of the audio files which are stored in memory 14 or which may be accessible by the processing unit 13 via the network 30 at the server 50. As shown in FIG. 2, the list of artists comprises five artists 201-205. In case more artists are present, an additional (not shown) scroll bar may be used to extend the list of artists. For each artist a selection box 211-215 is provided. With appropriate input means, for example a mouse or a stylus and a touch screen, the user can select for each artist the number or quantity of titles or tracks to be added to the playlist from this artist by adjusting the number of titles in the corresponding selection box 211-215. In the example shown in FIG. 2, the user selects six titles to be played from “The Beatles”, two titles to be played from “Bon Jovi”, and four titles to be played from “Linkin Park”. According to this user selection, the processing unit 13 selects automatically the respective quantity of titles from the audio files stored in memory 14. As shown in the exemplary embodiment of FIG. 2, six titles from “The Beatles”, two titles from “Bon Jovi” and four titles from “Linkin Park” are selected from the audio files stored in memory 14. If for example more than six titles from “The Beatles” are present in the memory 14, the processing unit may for example select six audio files randomly from the more than six Beatles audio files. However, the selection may also be based on user-preferred audio files, for example, the processing unit 13 may select those files from the Beatles audio files to which the user was listening in the past most frequently.

After the user has selected for each of the artists 201-205 a desired number of tracks or titles, a new playlist is set up. The titles within the playlist may be mixed randomly or may be re-arranged by the user before the audio files of the playlist are played back by the device 10.

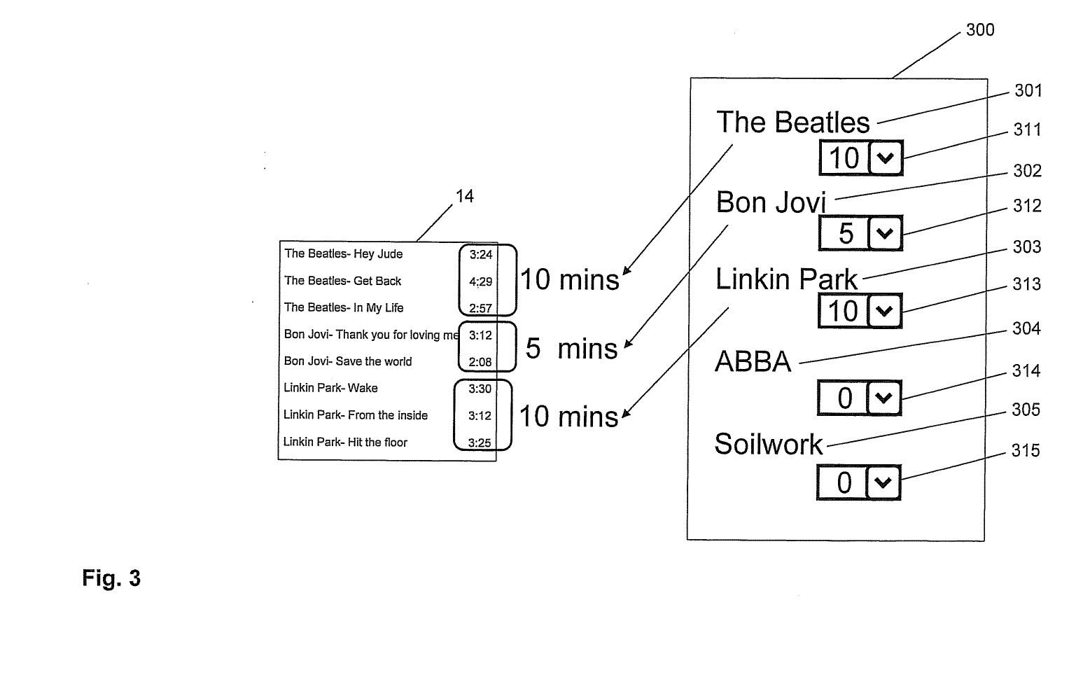

Another embodiment of the present invention will be described below in connection with FIGS. 1 and 3.

FIG. 3 shows a menu 300 displaying a user a list of artists 301-305. Selection boxes 311 to 315 assigned to the artists 301-305 enable the user to select how many minutes of music from the respective artist shall be added to a playlist. In the exemplary embodiment shown in FIG. 3, the user has selected ten minutes for “The Beatles”, five minutes for “Bon Jovi”, and ten minutes for “Linkin Park”. Upon the user selection the processing unit 13 selects from the audio files stored in memory 14 or accessible via the network 30 at the server 50, one or more tracks from the respective artist such that the required playing time is approximately met. For enabling this, each track or each audio file of memory 14 or server 50 provides a playing time information indicating a time duration which is required for playing back the audio file. In the example shown in FIG. 3, the processing unit 13 selects the following three tracks of “The Beatles”: a first track “Hey Jude” with a playing time of 3 minutes and 24 seconds, a second track “Get Back” with a playing time of 4 minutes and 29 seconds, and a third track “In My Life” with a playing time of 2 minutes and 57 seconds. Thus, a total playing time for “The Beatles” of 10 minutes and 50 seconds is reached. In the same way two tracks of “Bon Jovi” are selected having together a total playing time of approximately 5 minutes and another three tracks of “Linkin Park” are selected having together a total playing time of approximately 10 minutes. The selected tracks are added by the processing unit 13 to the playing list which may be displayed to the user for rearranging the selected tracks into a desired order. Furthermore, the tracks may be added to the playlist in a randomized order.

In case a lot of tracks of one artist, for example “The Beatles”, are stored in memory 14 or at the server 50, the processing unit 13 may find several combinations of tracks of this artist, wherein each of these combinations has a total playing time of approximately the desired duration, for example 10 minutes. In this case, the processing unit 13 may select a combination of tracks which fits best to the desired total playing time or the processing unit 13 may select a combination comprising tracks the user prefers.

In the examples shown above in connection with FIGS. 2 and 3, the selection criteria in the menus 200 and 300 is the artist of the audio files. However, instead of the artist a name of an album or a music genre may be used. In case of an album, the user may select the number of tracks of an album which shall be added to the playlist or a total playing time of tracks of an album which shall be added to the playlist. Likewise, the user may set up a playlist based on the genre of the audio files, for example by selecting a number of audio files of a first genre, for example pop music, to be added to the playlist, and by selecting a number of audio files of a second genre, for example jazz music, which shall be selected and added to the playlist.

While exemplary embodiments have been described above, various modifications may be implemented in other embodiments. For example, the characteristic upon which a number or quantity of audio files or a total playing time is selected by the user, may be an album name, a name of an artist or interpreter, or a genre of the audio files, and may further comprise a year when the songs was published, or a quality of the audio file, for example a sampling rate.

Finally, it is to be understood that all the embodiments described above are considered to be comprised by the present invention as it is defined by the appended claims.

What is claimed is:

1. A method for setting up a list of audio files, the method comprising:
determining automatically at least one group of audio files from a plurality of audio files, the audio files of each of the at least one group providing a group specific common characteristic,
requesting from a user for each of the at least one group a respective value defining a number of audio files to be selected from the respective group for the list of audio files,
selecting automatically for each of the at least one group the requested number of audio files from the respective group, and
adding automatically the selected audio files to the list of audio files.

2. The method according to claim 1, wherein the group specific common characteristic comprises a name of at least one of an interpreter or an artist of the audio file.

3. The method according to claim 1, wherein the group specific common characteristic comprises a name of an album to which the audio file belongs.

4. The method according to claim 1, wherein the group specific common characteristic comprises a genre of the audio file.

5. The method according to claim 1, wherein the step of selecting the requested number of audio files comprises selecting randomly for each of the at least one group the requested number of audio files from the respective group.

6. An audio reproduction device, comprising a processing unit having access to a plurality of audio files, wherein the processing unit is adapted to:
determine at least one group of audio files from the plurality of audio files, the audio files of each of the at least one group providing a group specific common characteristic,
request from a user of the device for each of the at least one group a respective value defining a number of audio files to be selected from the respective group,
select for each of the at least one group the requested number of audio files from the respective group, and
add the selected audio files to a list of audio files.

7. The device according to claim 6, wherein the device comprises a device selected from the group comprising a mobile phone, a personal digital assistant, a mobile navigation system, a mobile music player and a mobile computer.

8. A method for setting up a list of audio files, the method comprising:
determining automatically at least one group of audio files from a plurality of audio files, the audio files of each of the at least one group providing a group specific common characteristic, wherein each audio file comprises a playing time information indicating a time duration required for playing back the audio file,
requesting from a user for each of the at least one group a respective time duration information corresponding to a desired total playback time of audio files to be selected from the respective group,
selecting automatically for each of the at least one group one or more audio files such that a total playback time of the selected one or more audio files corresponds approximately to the requested time duration information for the respective group, and
adding automatically the selected one or more audio files to the list of audio files.

9. The method according to claim 8, wherein the group specific common characteristic comprises a name of an artist and or an interpreter of the audio file.

10. The method according to claim 8, wherein the group specific common characteristic comprises a name of an album to which the audio file belongs.

11. The method according to claim 8, wherein the group specific common characteristic comprises a genre of the audio file.

12. An audio reproduction device, comprising a processing unit having access to a plurality of audio files, wherein the processing unit is adapted to:
determine at least one group of audio files from the plurality of audio files, the audio files of each of the at least one group providing a group specific common characteristic, wherein each audio file comprises a playing time information indicating a time duration required for playing back the audio file,
request from a user for each of the at least one group a respective time duration information corresponding to a desired total playback time of audio files to be selected from the respective group,
select for each of the at least one group one or more audio files such that a total playback time of the selected one or more audio files corresponds approximately to the requested time duration information for the respective group, and
add the selected one or more audio files to a list of audio files.

13. The device according to claim 12, wherein the device comprises a device selected from the group comprising a mobile phone, a personal digital assistant, a mobile navigation system, a mobile music player and a mobile computer.
